(19) United States
(12) Patent Application Publication
(10) Pub. No.: US 2007/0079263 A1
(43) Pub. Date: Apr. 5, 2007

(54) Design method of semiconductor integrated circuit device, a program, and the support method of measurement evaluation

(75) Inventors: Yasuyoshi Noguchi, Tokyo (JP); Kei Mohara, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP., Tokyo (JP)

(21) Appl. No.: 11/607,072

(22) Filed: Dec. 1, 2006

Related U.S. Application Data
(63) Continuation-in-part of application No. 11/262,814, filed on Nov. 1, 2005.

(30) Foreign Application Priority Data
Dec. 2, 2005 (JP) 2005-349613
Nov. 2, 2004 (JP) 2004-319340

(51) Int. Cl. G06F 17/50

(52) U.S. Cl. 716/2

(57) ABSTRACT

Sample evaluation is effectively conducted within a short period of time using a general purpose software by changing programs, data files and register libraries in accordance with measuring specifications of semiconductor integrated circuit devices. The automatic measuring program used for sample evaluation includes a basic standard frame and can realize flexible automatic measurements of various kinds of semiconductor integrated circuit device by changing combination of the measuring program module group, measuring parameter module group, measuring instrument driver module group, register library, measuring program data file, and measuring condition data file.

### CROSS-REFERENCE TO RELATED APPLICATION

This application is a continuation-in-part of U.S. application Ser. No. 11/262,814 filed Nov. 1, 2005, which is incorporated herein by reference in its entirety.

This application also claims the benefit of Japanese Patent Application No. 2004-319340 filed Nov. 2, 2004, and Japanese Patent Application No. 2005-349613 filed Dec. 2, 2005, both of which are incorporated herein by reference in their entirety.

### BACKGROUND OF THE INVENTION

The present invention relates to a trial manufacture evaluation technique of semiconductor integrated circuit devices and particularly to an effective technique for application into trial manufacture evaluation of semiconductor integrated circuit device based on a software.

In a combined analog/digital semiconductor integrated circuit device represented by a semiconductor integrated circuit device for RF (radio-frequency) processes which is widely utilized in a mobile phone as one of the mobile communication terminals, it is very important to provide, in the earlier stage, a semiconductor integrated circuit device as a product manufactured in trial to customers, with improvement thereof in versatility of products and shortening in the development period.

As one of evaluation of trial manufacture of semiconductor integrated circuit device (sample), a technology has been proposed, in which a test signal generated from a personal computer or the like with a software for evaluation is mapped to various registers forming a logic unit of a semiconductor integrated circuit device and the logic unit is transitioned to various states. Moreover, a technology for reading out information stored in a semiconductor integrated circuit device has also been proposed. In addition, a technology for remotely controlling measuring instruments has also been proposed.

### SUMMARY OF THE INVENTION

However, the inventors of the present invention has found that following problems are left unsolved in the sample evaluation technique of semiconductor integrated circuit device on the basis of software explained above.

That is, an evaluation software cannot be used with flexibility into a plurality of kinds of semiconductor integrated circuit device because such evaluation software is different in specifications of register and measuring conditions for each kind of the semiconductor integrated circuit device.

Therefore, an exclusive program (evaluation program) must be newly developed for each kind of semiconductor integrated circuit device, and design period of such program may also be extended, allowing considerable rise of manufacturing cost.

Moreover, changes in circuit, specifications of register, or in measuring conditions are generated in some cases, for example, by customers' request in development of semiconductor integrated circuit devices. Therefore, if corrections of developed exclusive programs are requested, correcting processes of program are further required, resulting in occurrence of a problem that the real-time measures for such program design request cannot be conducted.

In addition, if a plurality of requests for program development are issued simultaneously, such program development must be made for each kind of semiconductor integrated circuit device by determining development priority for the corresponding circuit devices of a plurality of kinds. However, if program correction is required, the real-time measures to a plurality of kinds of semiconductor integrated circuit device cannot likely be ensured.

Moreover, since specifications for measurements (measuring sequence, conditions of measuring instruments, measuring parameters, specifications of registers) of semiconductor integrated circuit device are independent in every kind of circuit device and in unit of measuring items, a subject is to provide standardization of evaluation programs because countless number of measurement specifications and combinations thereof may be considered.

It is therefore an object of the present invention to provide techniques to effectively perform sample evaluation of semiconductor integrated circuit device in lower cost within a short period through combination of the basic software, register library, and data file by changing and selecting register library in accordance with structures and functions of various control registers of semiconductor integrated circuit device and also by changing and selecting program module groups and data file in accordance with various measuring conditions.

The aforementioned and the other objects and novel features of the present invention will become apparent from description of this specification and the accompanying drawings.

The typical inventions among those disclosed in the present specification will be briefly explained below.

A design method of semiconductor integrated circuit device of the present invention comprises a register setting program core designed as a general purpose program corresponding to all semiconductor integrated circuit devices for sample evaluation to provide a standard function not depending on product regarding register control and a plurality of register libraries formed of data prepared in accordance with a register structures individually corresponding to each product of the semiconductor integrated circuit device. Each of the register libraries explained above is provided in each product with at least addresses for designating the desired registers in the semiconductor integrated circuit device and with word information pieces indicating the data stored in the registers. Therefore, on the occasion of conducting evaluation of trial manufacture of the desired semiconductor integrated circuit device, the register library corresponding to register structure of semiconductor integrated circuit device for evaluation of trial manufacture is selected from the register libraries. The word information stored in the register libraries is the information, for example, to be stored into a control register of the desired semiconductor integrated circuit device.

Moreover, the design method of semiconductor integrated circuit device of the present invention proposes that bit length of word information is stored in the register library.

In addition, the design method of semiconductor integrated circuit device of the present invention proposes that a register setting program core includes a GUI (Graphical User Interface) control function for displaying GUI parts and register maps. The register library includes structure of manipulating function displayed on the basis of the GUI control function and GUI information for changing display contents and also changes the word information with the manipulating function displayed by the GUI control function.

Moreover, the design method of semiconductor integrated circuit device of the present invention proposes that the register library has serial communication pattern information as output pattern of serial signal to be outputted from the semiconductor integrated circuit device. The serial communication pattern information is an output pattern used when the word information is converted to the communication pattern of serial signal and is then outputted to the semiconductor integrated circuit device. The register setting program is provided to convert the word information of product as the object of evaluation of trial manufacture into the serial signal on the basis of the serial communication pattern information.

Moreover, the design method of semiconductor integrated circuit device of the present invention proposes that the serial communication pattern information includes the information for assigning transmitting and receiving terminals at a communication interface used to output communication pattern of the serial signal. The register setting program is capable of outputting the word information converted to the serial signal to the semiconductor integrated circuit device on the basis of the information to assign the transmitting and receiving terminals.

Moreover, the design method of semiconductor integrated circuit device of the present invention proposes that the register library has a data inter-relating function for setting relation of data and this data inter-relating function automatically changes, when the word information of the desired register is changed to the optional setting conditions, the word information of all registers related to the desired register to have the relationship with the setting condition of the desired register on the basis of the inter-relating information.

Moreover, the other inventions of the present invention will also be described below briefly.

The present invention is a computer-executable program coupled to a semiconductor integrated circuit device comprising analog circuits used for operation control of the analog circuits, including the processes for controlling the computer to enable that the information to be set to the register is set on the computer, the preset information is then set to the register of analog circuits, and information outputted from the semiconductor integrated circuit device is inputted in accordance with the operations of the same semiconductor integrated circuit device.

Moreover, the program explained above of the present invention includes the processes for enabling selection of the register defining information in accordance with the analog circuits of the coupled semiconductor integrated circuit device from the defining information for defining a plurality of registers.

Moreover, the computer explained above of the present invention is coupled to measuring instruments to perform measurement of operations of the analog circuits using the measuring instruments and the program explained above includes the processes for controlling the computer to enable input of the measuring information obtained through measurements with the measuring instruments.

Moreover, the present invention includes the processes for controlling the computer to enable setting of the information to be set to the measuring instruments and setting of the preset information to the measuring instruments.

Moreover, the present invention is a computer-executable program coupled to a semiconductor integrated circuit device including analog circuits and used for measuring operations of the semiconductor integrated circuit device. This program comprises a program for controlling evaluation of the semiconductor integrated circuit device, a program for measuring the semiconductor integrated circuit device which is constituted for switching the semiconductor integrated circuit device in accordance with product identifying information to be identified, a measuring parameter in accordance with the measuring program, and a measuring instrument driver in accordance with the measuring program and also comprises the processes for controlling the computer to enable reading of the product identifying information of the semiconductor integrated circuit device as the object of measurement of operations by execution of program on the computer, selection of the measuring program in accordance with the product identifying information, selection of the measuring parameter in accordance with the selected measuring program, selection of the measuring instrument driver in accordance with the selected measuring program, and measuring operations of the semiconductor integrated circuit device using the evaluation control program, measuring program selected in accordance with the product identifying information, measuring parameter, and measuring instrument driver.

Moreover, the present invention proposes that the measuring program selected from a plurality of measuring programs in accordance with the product identifying information comprises the processes for enabling setting of the continuous measuring operations for executing continuously a plurality of measuring programs and the single measuring operations for executing one measuring program.

Moreover, the present invention proposes that a measuring parameter selected from a plurality of measuring parameters in accordance with the measuring program includes the parameters including power supply voltage, operating frequency (period), and temperature of the semiconductor integrated circuit device to be measured and amplitude and frequency (period) of the input/output information. In addition, the present invention comprises processes for switching and setting the measuring parameter in accordance with switching of the measuring program selected from a plurality of measuring programs as the same product identifying information.

Moreover, the present invention proposes that the measuring instrument driver selected from the plural measuring instrument drivers in accordance with the measuring program is capable of operating measuring instruments coupled to the computer used for measuring operations of the semiconductor integrated circuit device and also comprises the processes for controlling the computer for enabling input of the measuring information measured with the measuring instruments through execution of the program.

Moreover, the present invention comprises a process for newly adding a plurality of measuring parameters on the computer.

Moreover, the present invention comprises a process to newly adding the measuring instrument driver on the computer.

The effects of the typical invention among the inventions disclosed in the present specification will be briefly explained below.

(1) Since a sample of the semiconductor integrated circuit device as a different product can be evaluated easily without alteration of a register setting program to be combined with a register library, by changing and selecting the register library having the product information of every product as the design object, development cost of the program for evaluation of trial manufacture can be remarkably reduced, and the period required for development can also be shortened.

(2) Moreover, since the register library information peculiar to every product can only be changed and selected, flexible measures can be taken within a short period of time, even if changes are generated in the circuits of the semiconductor integrated circuit device and register specifications.

(3) Since flexible automatic measurements can be realized for various kinds of the semiconductor integrated circuit device, development cost of program can be reduced to a large extent.

(4) Automatic measuring environment of the semiconductor integrated circuit device can be constituted easily within a short period of time.

(5) With the effects (1) to (4) explained above, manufacturing cost of the semiconductor integrated circuit device can be lowered while reliability of the same semiconductor integrated circuit device is improved.

(6) With the effects (1) to (4), the period required for product evaluation of the semiconductor integrated circuit device can be shortened remarkably.

### BRIEF DESCRIPTION OF THE DRAWINGS

FIG. 1 is an explanatory diagram of a sample evaluation system according to the first embodiment of the present invention;

FIG. 2 is an explanatory diagram showing an example of a program structure of resister setting program installed into a host constituting a sample evaluation system;

FIG. 3 is an explanatory diagram showing an example of contents of a register library provided in the register setting program of FIG. 2;

FIG. 4 is an explanatory diagram of register map information constituting the register library;

FIG. 5 is a signal timing chart showing an example of write operation of serial communication pattern information constituting the register library of FIG. 3;

FIG. 6 is a signal timing chart showing an example of read operation of serial communication pattern information constituting the register library of FIG. 3;

FIG. 7 is an explanatory diagram showing an example of transmitting and receiving pin information constituting the register library of FIG. 3;

FIG. 8 is an explanatory diagram showing respectively display examples of the GUI display screen for every product displayed on the monitor of host provided for the sample evaluation system of FIG. 1;

FIG. 9 is a flowchart showing examples of processes of the register setting program by the sample evaluation system of FIG. 1;

FIG. 10 is an explanatory diagram of the sample evaluation system by the second embodiment of the present invention;

FIG. 11 is an explanatory diagram showing an example of function contents of an automatic measuring program installed into the host constituting the sample evaluation system of FIG. 1;

FIG. 12 is an explanatory diagram showing a structure of an automatic measuring program of FIG. 11;

FIG. 13 is an explanatory diagram showing examples of structure of a measuring program module group in the automatic measuring program of FIG. 12;

FIG. 14 is a flowchart showing examples of processes for utilizing the measuring program module group in the automatic measuring program of FIG. 12;

FIG. 15 is an explanatory diagram showing examples of application of the measuring parameter module group in the automatic measuring program of FIG. 12;

FIG. 16 is an explanatory diagram showing examples of application of the measuring instrument driver module group in the automatic measuring program of FIG. 12;

FIG. 17 is an explanatory diagram showing examples of customer evaluation support utilizing the automatic measuring program of FIG. 12; and

FIG. 18 is a flowchart showing examples of customer evaluation support utilizing the automatic measuring program of FIG. 12.

### DETAILED DESCRIPTION OF THE PREFERRED EMBODIMENTS

The preferred embodiments of the present invention will be explained below in detail with reference to the accompanying drawings. The like elements are designated with the like reference numerals throughout the drawings in order to explain the preferred embodiments and the same explanation is avoided here.

### FIRST EMBODIMENT

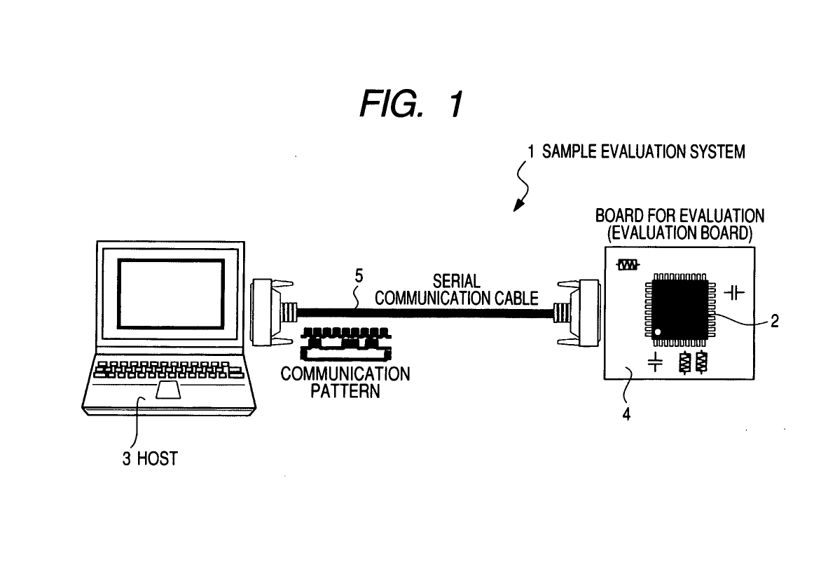

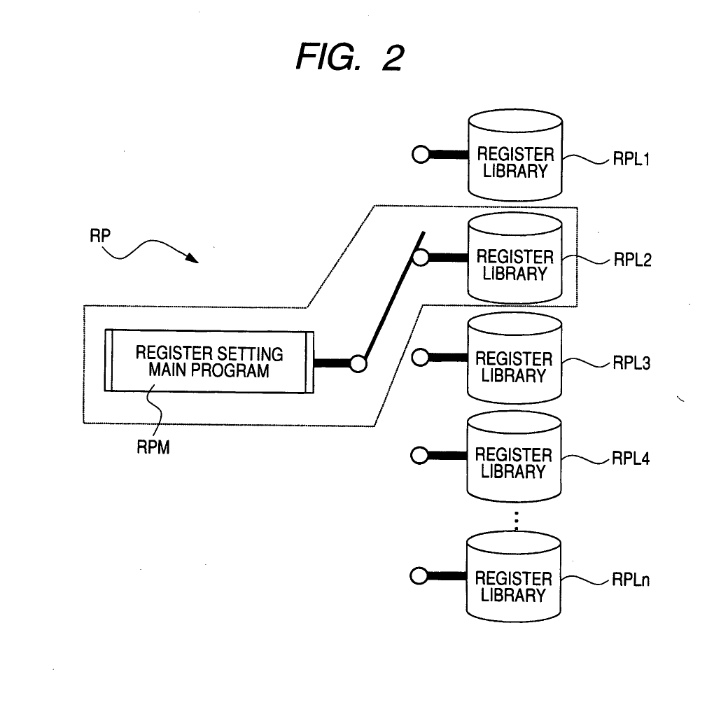

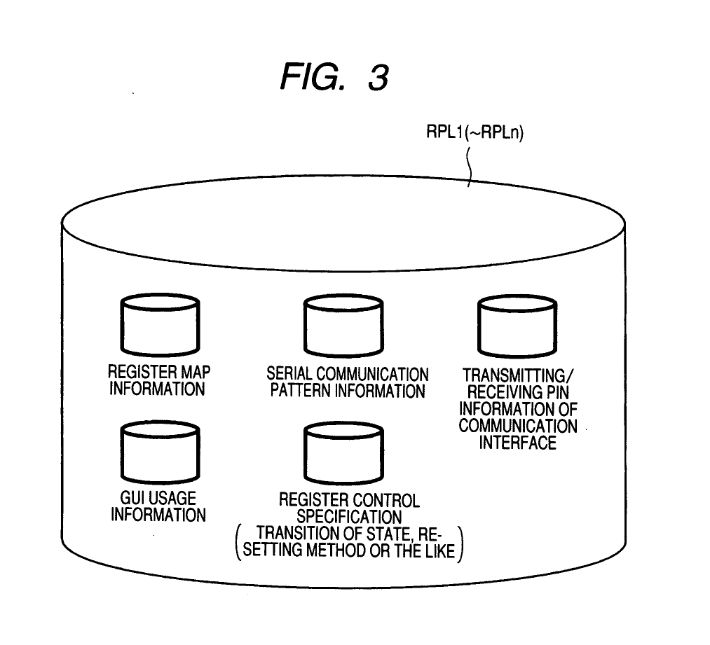

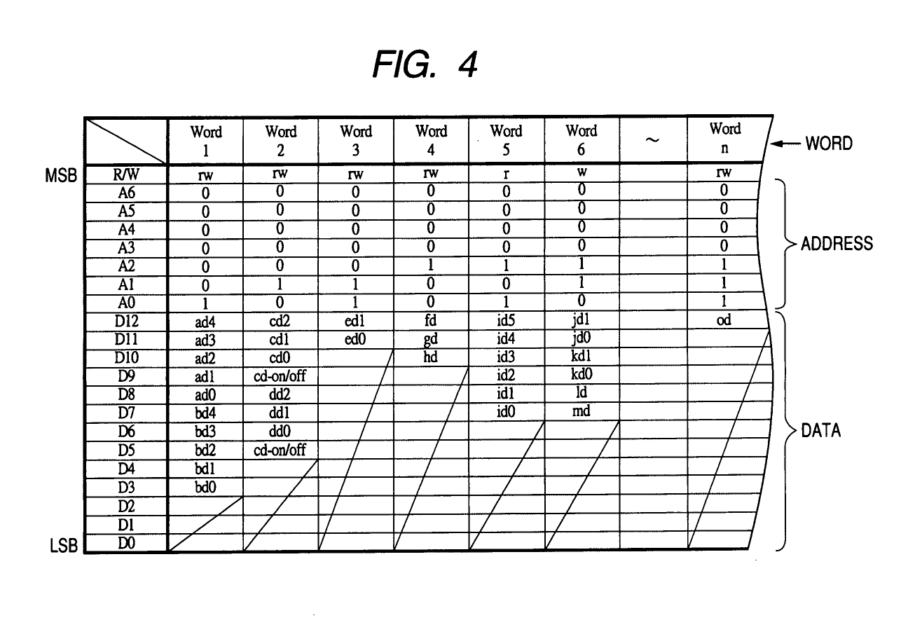

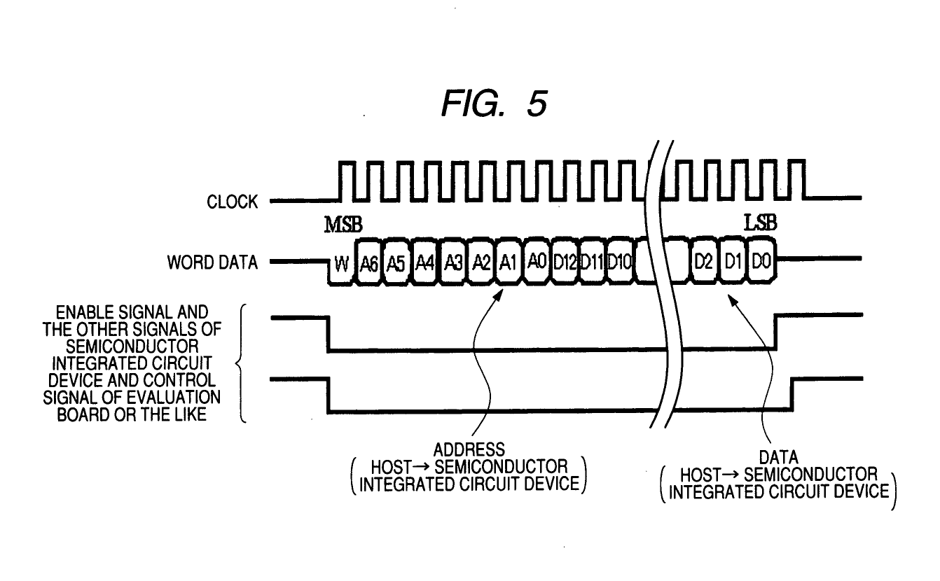

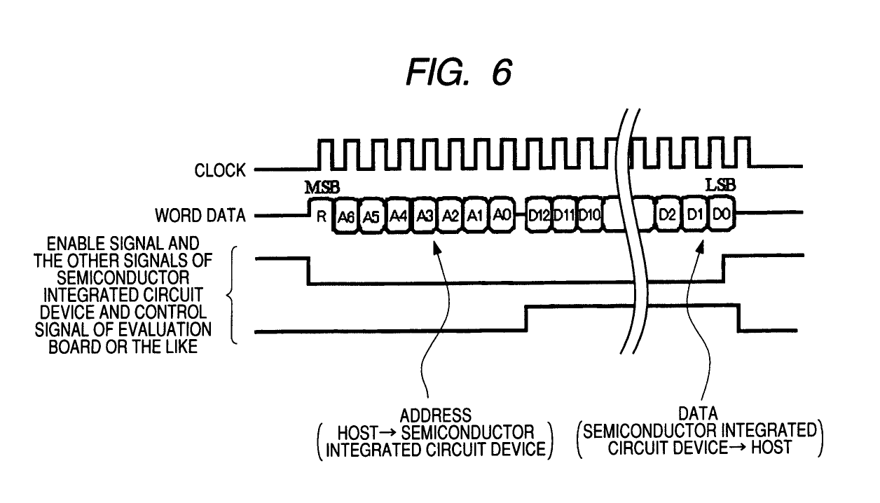

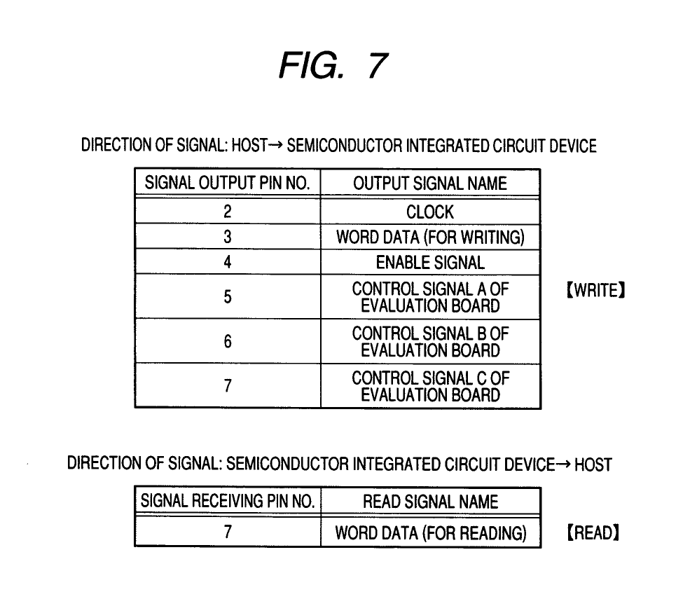

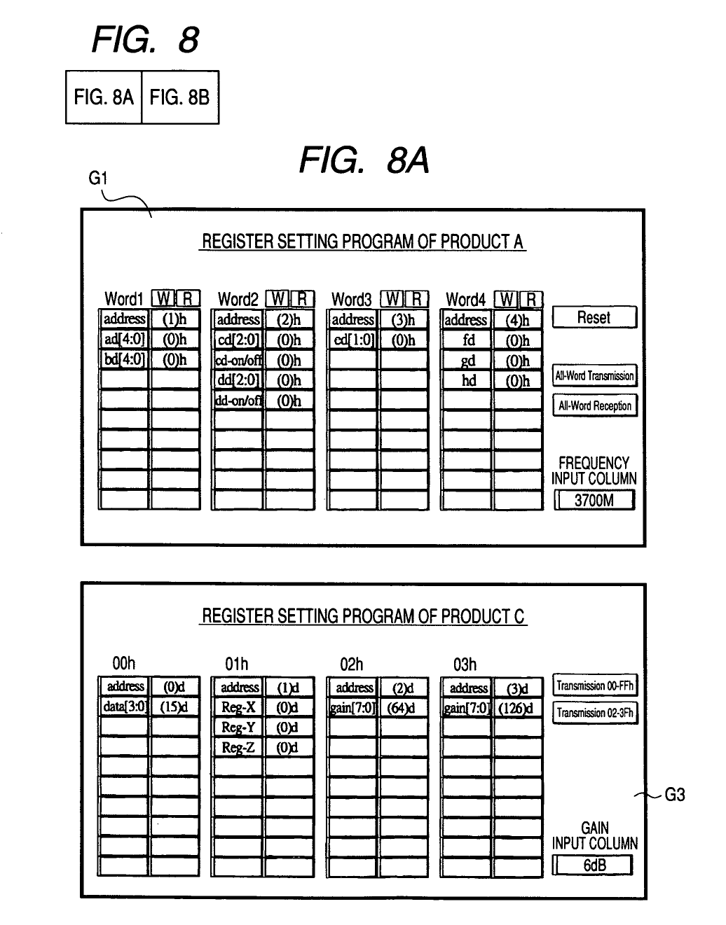

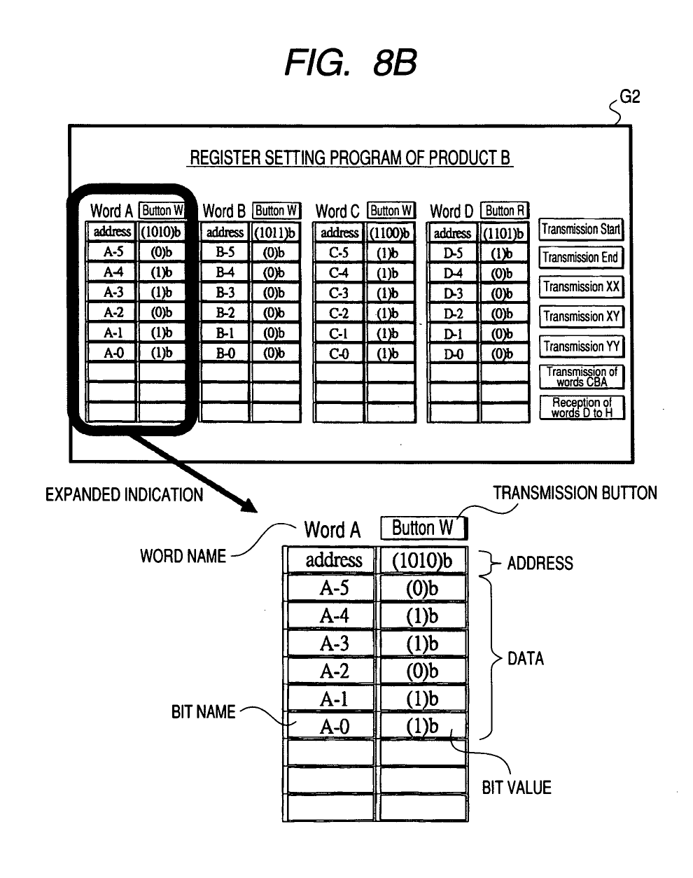

FIG. 1 is an explanatory diagram of a sample evaluation system as the first embodiment of the present invention. FIG. 2 is an explanatory diagram showing an example of a program structure of a register setting program installed into a host forming the sample evaluation system of FIG. 1. FIG. 3 is an explanatory diagram showing an example of contents of a register library provided in the register setting program of FIG. 2. FIG. 4 is an explanatory diagram of register map information forming the register library of FIG. 3. FIG. 5 is a signal timing chart showing an example of write operation in serial communication pattern information forming the register library of FIG. 3. FIG. 6 is a signal timing chart showing an example of read operation in the serial communication pattern information forming the register library of FIG. 3. FIG. 7 is an explanatory diagram showing an example of transmitting/receiving pin information forming the register library of FIG. 3. FIG. 8 is an explanatory diagram respectively showing display examples of the GUI display screen of every product displayed on the monitor of host provided for the sample evaluation system of FIG. 1. FIG. 9 is a flow chart showing examples of processes of the register setting program based on the sample evaluation system of FIG. 1.

In the first embodiment, the sample evaluation system 1 executes sample evaluation, for example, of an analog/digital-mixed semiconductor integrated circuit device 2. The sample evaluation system 1 includes, as shown in FIG. 1, a host 3 such as personal computer and a board 4 for evaluation.

The host 3 is coupled with board 4 for evaluation via a serial communication cable 5. In the host 3, the serial communication cable 5 is coupled by an interface for communication of the host 3 (for example, a printer port). Coupling between this serial communication cable 5 and the host 3 may be made with a means other than the printer port, and may be such as an interface which is provided with the number of terminals (for example, three or more terminals) required for communication of data to a semiconductor integrated circuit device in order to output serial signal.

Coupling between the host 3 and the evaluation board 4 may be made via a communication interface which can output not only the serial signal but also the parallel signal. In addition, it is also possible to transmit data to a semiconductor integrated circuit device by utilizing USB interface and radio communication. Any type of general purpose interface may be used whenever it is capable of transmitting and receiving the data required for sample evaluation.

A register setting program RP (FIG. 2) is installed to the host 3 for conducting sample evaluation of the semiconductor integrated circuit device 2 mounted to the evaluation board 4.

The register setting program RP executes sample evaluation through mapping by writing word (FIG. 4) data to various registers forming a logic unit of the semiconductor integrated circuit device 2 by generating various communication patterns and is also capable of reading information set to these registers and information stored in the semiconductor integrated circuit device to the host 3 as required during the sample evaluation.

FIG. 2 is an explanatory diagram showing an example of a program structure of the register setting program RP.

The register setting program RP includes, as shown in the figure, a register setting main program (register setting program core) RPM and register libraries RPL1 to RPLn provided for each product (kind of product) of the semiconductor integrated circuit device 2.

The register setting main program RPM is the general purpose program corresponding to all semiconductor integrated circuit devices as the objects of the sample evaluation having the standard function not depending on the product regarding register control.

Functions of this register setting main program include, for example, GUI control (GUI control function), security control of register libraries RPL1 to RPLn, communication control, platform control, read of register library, definition of register library, measure of semiconductor integrated circuit device, and measure of automatic measuring program, or the like.

The register libraries RPL1 to RPLn may be provided with a protecting function with which at least the register map information among the information pieces constituting the register libraries RPL1 to RPLn is not reprogrammed with a third party such as a user. Accordingly, security can be improved by preventing diversion and reprogramming of the register libraries RPL1 to RPLn. In addition, this protecting function can prevent erroneous operations of products caused by change of the value to be set to various control registers through falsification of register library.

The GUI control is the function to display the GUI parts and register map or the like, including many display information pieces required for sample evaluation such as a plurality of registers having the predetermined number of bits, control buttons for defining control of communication with the evaluation board and character information required for various controls.

Security control of register library is the function to protect register library and register map or the like.

Communication control is the function to conduct conversion to serial signal of the word data (word information) in accordance with serial communication pattern control included in the register library, transmission of word data converted to the serial signal, reception of the register information from the semiconductor integrated circuit device, and analysis of the transmitting and receiving data, or the like.

Platform control is the function corresponding to various OSs (Operating Systems) in the host 3.

Read of register library is the function to execute read register library data file to a memory of the host 3 and analysis of library data description.

Definition of register library is the function to define serial communication pattern, transmission and reception of printer port (communication interface), communication interface and address of the host 3, and usability of GUI, or the like.

Measure of semiconductor integrated circuit device is the function to conduct record of history in change and setting of register control manipulation (register macro record) and re-execution of register control manipulation in accordance with history of setting and change (register macro execution).

FIG. 3 is an explanatory diagram showing an example of contents of register library RPL1 (to RPLn).

The register libraries RPL1 to RPLn are data prepared in accordance with register structure of the semiconductor integrated circuit device as the target of each product, includes register map information, serial communication pattern information, transmitting and receiving pin information, usage information of GUI (GUI information), and register control specifications. If necessary, the predetermined control data for each product may be included in addition to the information listed above.

Register map information includes, as shown in FIG. 4, a plurality of words (word 1 to word n) corresponding to the register of semiconductor integrated circuit device as the target. The word indicates the address information for designating the particular register and data stored in the particular register.

In each word of FIG. 4, “RW” bit (leading bit) indicates write (w) operation or read (r) operation. “A6 to A0” bits indicate address of register. “D12 to D0 bits indicate data stored in the register. It is also possible to introduce a structure that the initial data to be set to each control register may be transmitted as required.

Serial communication pattern information is the communication pattern information when data is written to the semiconductor integrated circuit device 2 from the host 3 and when data is read to the host 3 from the semiconductor integrated circuit device 2. The serial communication pattern information comprises, for example, control signals of semiconductor integrated circuit device 2 such as clock signal, word (FIG. 4) data and chip enable signal, and control signal of evaluation board 4, and moreover initial level/end level of signal, latch timing of register (rise/fall of clock signal), variable/fixed bit length of word, and bit location of address and data, etc.

The serial communication pattern information converts various signals and executes data communication between the host 3 and the semiconductor integrated circuit device 2 in accordance with communication control included in the register setting main program RPM.

FIG. 5 is a signal timing chart showing an example of the serial communication pattern information in the write operation to the semiconductor integrated circuit device 2 from the host 3. FIG. 6 is a signal timing chart showing an example of the serial communication pattern information in the read operation to the host 3 from the semiconductor integrated circuit device 2.

In FIG. 5 and FIG. 6, the timing charts of the clock signal, word data, and the other control signals are respectively shown to the lower side from the upper side.

First, during the write operation in FIG. 5, the word data is the Lo (“0”) level signal in which the leading bit indicates the write operation. Thereafter, address and data are sequentially outputted to the semiconductor integrated circuit device 2 from the host 3.

Moreover, during the read operation in FIG. 6, the leading bit of the word data becomes the Hi (“1”) level signal indicating the read operation. Thereafter, the address is outputted to the semiconductor integrated circuit device 2. Subsequently, the data of register corresponding to the address inputted from the semiconductor integrated circuit device 2 is outputted to the host 3 from the semiconductor integrated circuit device 2.

Here, patterns of signals transmitted to the semiconductor integrated circuit device are converted in the host 3 in accordance with the serial communication pattern information included in the register library, and combinations of signals to be transmitted in accordance with the serial communication pattern information may be selected variously.

FIG. 7 is an explanatory diagram showing an example of the transmitting/receiving pin information. The transmitting/receiving pin information in the write operation is indicated in the upper part, while the transmitting/receiving pin information in the read operation in the lower part.

The transmitting/receiving pin information includes, as shown in the figure, the signal output pin number and output signal name in the write operation and the signal receiving pin number and the read signal name in the read operation. The signal output pin number indicates the signal output pin number outputted to the semiconductor integrated circuit device 2 from the host 3 during the write operation, while the output signal name indicates a kind of signal outputted.

The signal receiving pin number indicates the pin number with which the host 3 receives the signal outputted from the semiconductor integrated circuit device 2 during the read operation, while the read signal name is the information indicating a kind of signal read from the semiconductor integrated circuit device 2.

For example, in the write operation, the enable signal to the semiconductor integrated circuit device 2 is outputted from the pin 4 of the communication interface of the host 3. Similarly, the word data is inputted from the semiconductor integrated circuit device 2 through pin 7 of the communication interface of the host 3 in the read operation.

The GUI usage information is used to change structure and display of the manipulating function displayed on the monitor of host 3. Moreover, this GUI usage information includes a data inter-relating function.

The data inter-relating function automatically changes a value of register by designating the particular bits of the related register on the basis of the particular formula.

For example, the semiconductor integrated circuit device for processing the radio frequency operated in a plurality of frequencies (channels), change of the reference frequency conforming to the relevant channel is required.

In this case, when the first condition is designated for the particular bits of a certain register, the bits of the related register are automatically changed so that the other related registers are all conforming to the first condition.

Similarly, when the second condition is designated for the particular bits of a certain register, the bits of the related register are automatically changed so that the other related registers are all conforming to the second condition.

FIG. 8 shows display examples of the GUI display screens G1 to G3 of each product displayed on the monitor of the host 3.

In this case, the GUI display screens G1 to G3 corresponding to the register table shown in FIG. 5 are displayed. For example, in the GUI display screen G2, the setting information pieces of the word A to word D are respectively displayed to the right side from the left side. At the extreme right end, the function keys assigned to provide the optimum usability for each product are displayed.

Moreover, in the GUI display screen G1, a “frequency input column” for setting the frequency used in the semiconductor integrated circuit device for processing the radio frequency is exclusively provided.

The right lower part of FIG. 8 is an enlarged portion of the setting information of the word A in the GUI display screen G2.

As the word setting information, the word name is displayed in the upper left side and the “Button W” (transmitting button) for transmitting the word data to the semiconductor integrated device from the host 3 is allocated in the right side of the word name.

Moreover, at the lower side of the word name and the “button W”, address information for designating a register allocated within the semiconductor integrated circuit device, bit name indicating the function of a plurality of bits included in the word, and data (bit value) stored in each register are displayed respectively.

These information pieces displayed with GUI on the monitor may be easily changed in accordance with the register map information and usage information of GUI stored in the register library. For example, control for display of the input column in the word, function setting of function keys and control for display of buttons can be set freely.

Register control specification is the information regarding the specifications such as state control and resetting method in the semiconductor integrated circuit device 2 for each product. For example, this specification controls the transmission sequence of word data to be transmitted to the register.

Moreover, the register libraries RPL1 (to RPLn) may be provided, as required, with the information such as output pin name of communication interface and explanation of function, in addition to the register map information, serial communication pattern information, transmitting/receiving pin information, GUI usage information, and register control specification.

Next, processes of the register setting program RP by the sample evaluation system 1 of the first embodiment of the present invention will be explained with reference to the flowchart of FIG. 9.

FIG. 9 shows the flowchart when the serial communication data is written to the semiconductor integrated circuit device 2 from the host 3 using the communication control and serial communication pattern information.

First, the semiconductor integrated circuit device as the product for sample evaluation is designated. The register setting program RP installed to the host 3 is driven, and the data of register library (for example, register library RPL1) corresponding to the designated semiconductor integrated circuit device stored in the hard disk of the host 3 is read into the memory of the host 3 (step S101).

Here, the preset register library RPL1 is read when the register setting program RP is driven. However, the register library previously read when the register setting program RP is driven may be changed as desired by the host 3.

Subsequently, the host 3 defines a register map, a serial communication pattern, and a transmitting/receiving pin of the communication interface on the basis of the register library RPL1 inputted and displays the GUI image (FIG. 8) of the semiconductor integrated circuit device 3 corresponding to the monitor of the host 3 (step S102).

Thereafter, a user manipulates the GUI image and changes as required the data stored in the word data to send an instruction for transmission such as “transmission of all words” (steps S103, S104). The host 3 generates the serial communication data (step S105) by synthesizing the serial communication pattern information of register library and the register map information, and outputs the serial communication data to the semiconductor integrated circuit device 2 from the communication interface thereof (step S106).

A distribution method of the register setting program RP to users will be explained, next.

The register setting program RP is distributed to users through the recording to a storage medium, for example, such as CD-ROM (Compact Disc-Read Only Memory), DVD-ROM (Digital Versatile Disc-ROM), DVD-RAM (DVD-Random Access Memory).

These storage media store, for example, the register setting program RP formed of any combination selected from the combination of the register setting main program RPM and register library of the semiconductor integrated circuit device as the relevant product, combination of the register setting main program RPM, register libraries RPL1 to RPLn and exclusive register setting program of the object product, and combination of register setting main program RPM and register libraries RPL1 to RPLn.

The optimum combination can be used for development of the semiconductor integrated circuit device, by distributing, to users, the storage medium storing the register setting program RP of a combination selected as a unit of provision.

Moreover, the register setting program RP can be used for easily realizing development of the register control for each object product by distributing the same program RP not only using the storage medium but also using, for example, the communication line such as the Internet.

Therefore, according to the first embodiment of the present invention, since sample evaluation of the semiconductor integrated circuit device 2 can be conducted easily only by changing the register libraries RPL1 to RPLn, development cost of the program can be lowered remarkably, development period can also be shortened, and moreover flexible care can be taken even if changes are generated in the circuit of semiconductor integrated circuit device and specification of register.

### SECOND EMBODIMENT

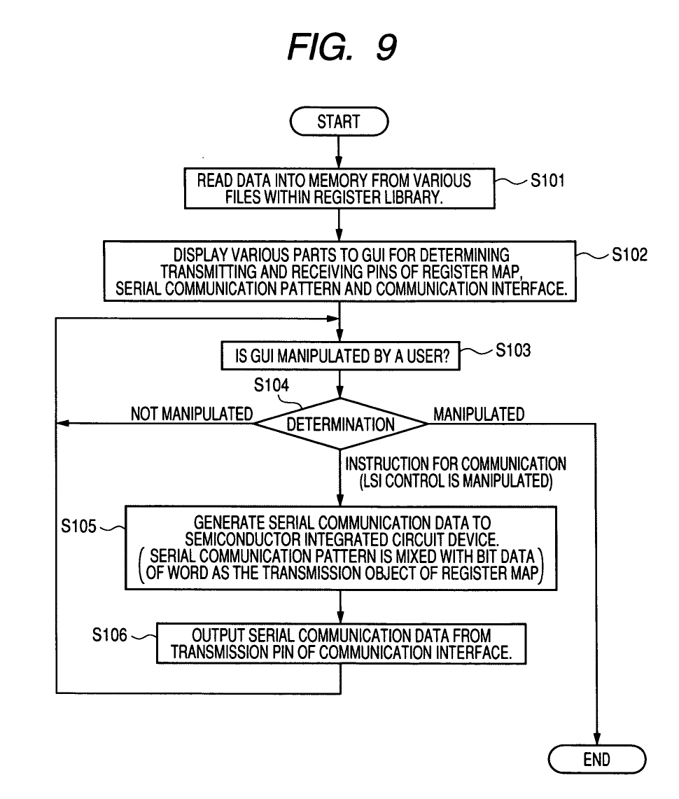

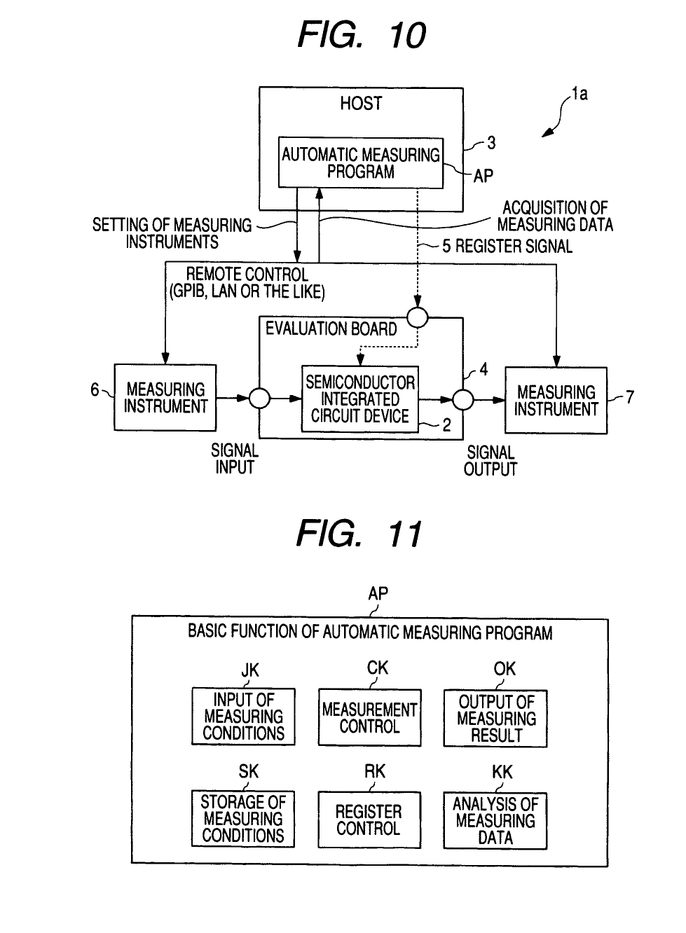

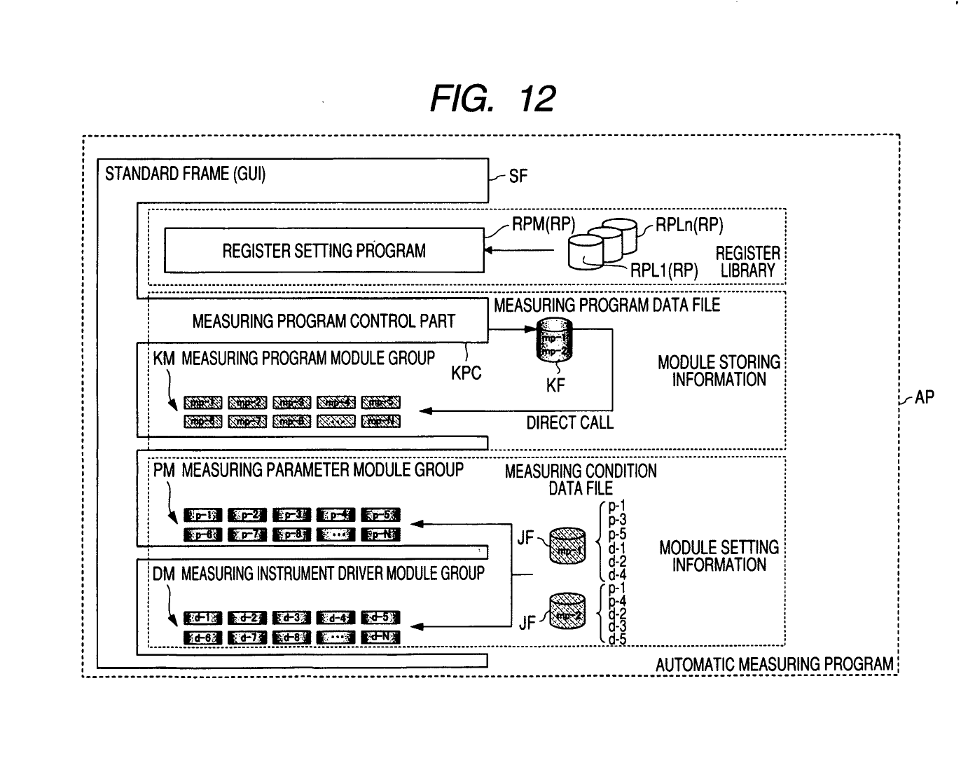

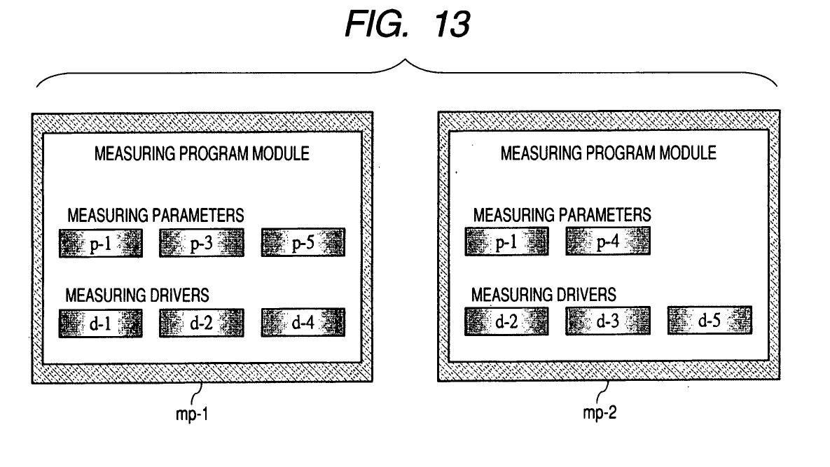

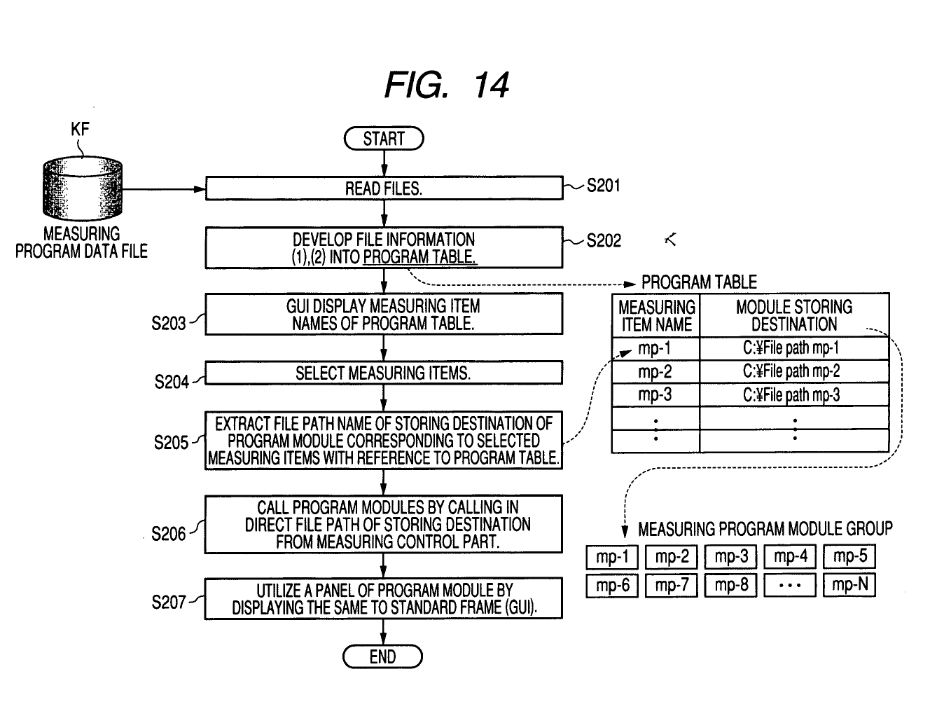

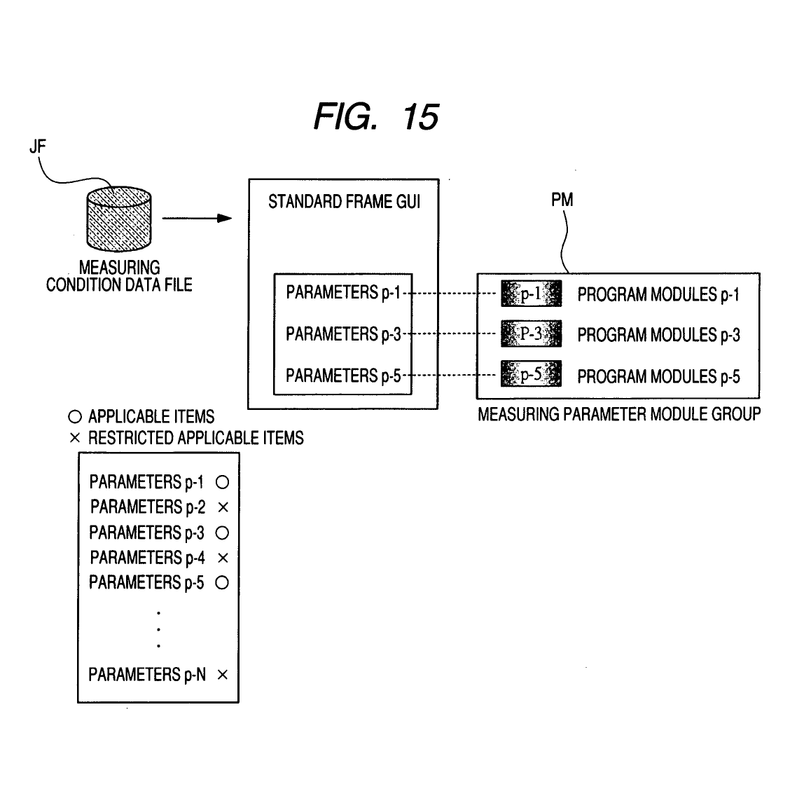

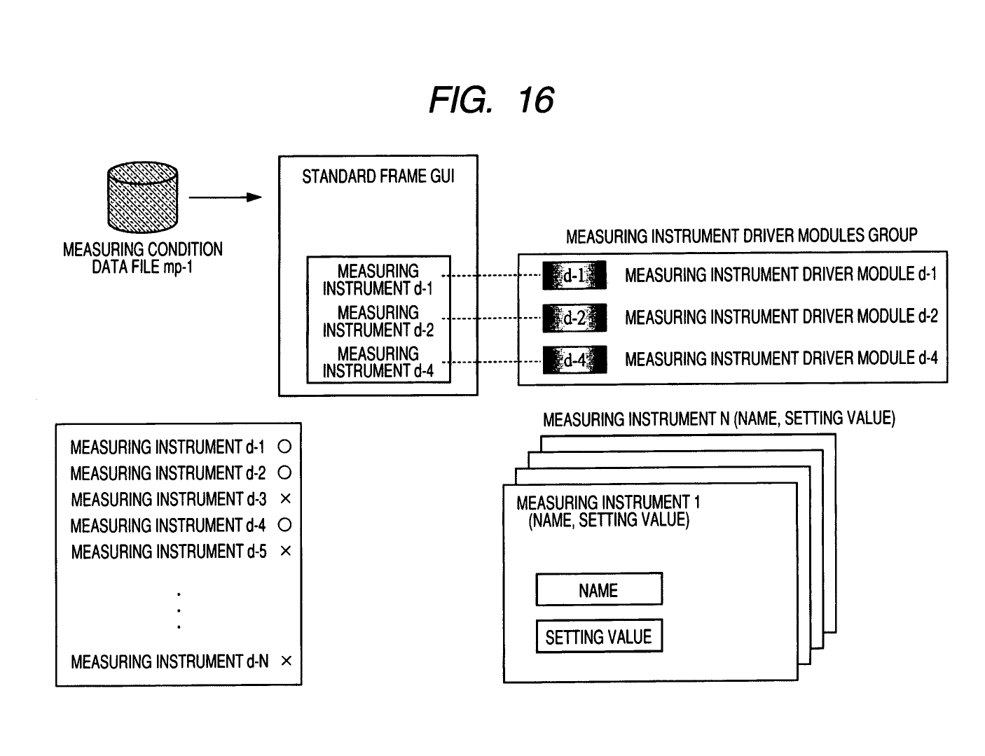

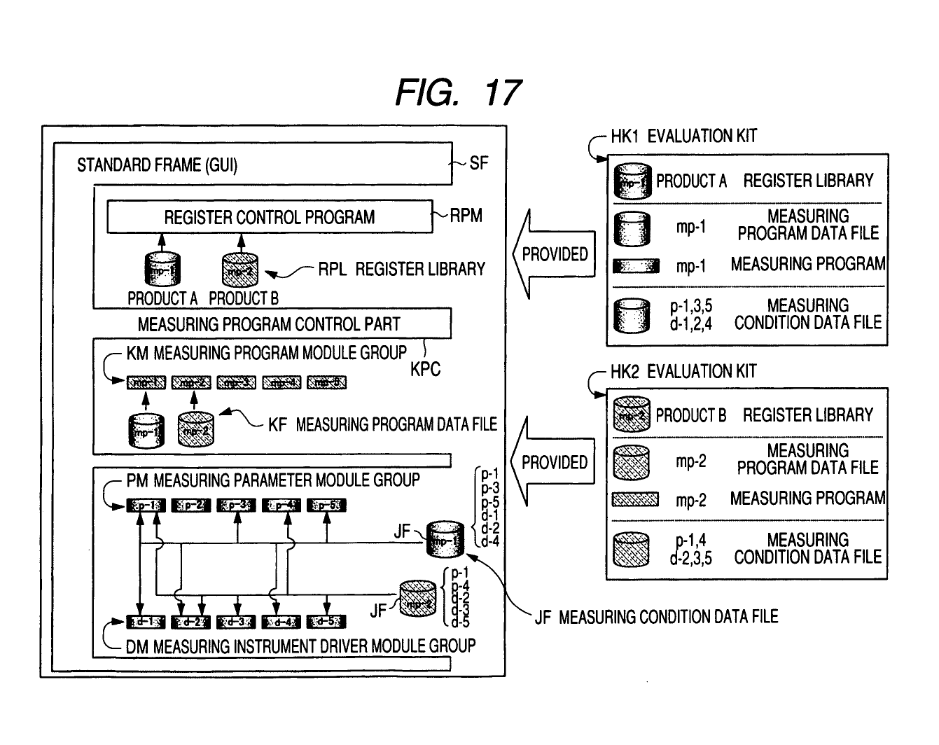

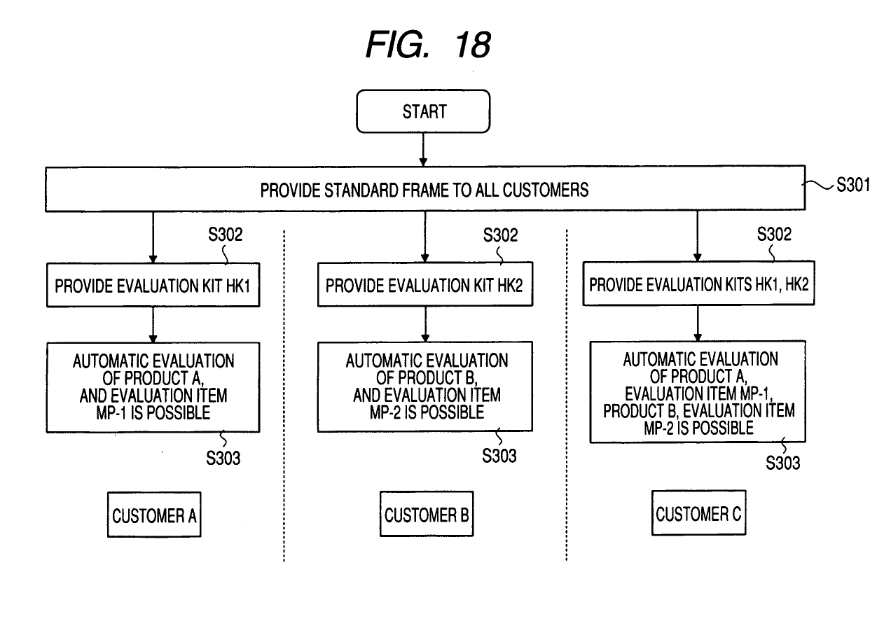

FIG. 10 is an explanatory diagram of the sample evaluation system as the second embodiment of the present invention. FIG. 11 is an explanatory diagram showing examples of functional contents of the automatic measuring program installed to the host constituting the sample evaluation system of FIG. 1. FIG. 12 is an explanatory diagram showing a structure of the automatic measuring program of FIG. 11. FIG. 13 is an explanatory diagram showing an example of structure of the measuring program module group in the automatic measuring program of FIG. 12. FIG. 14 is a flowchart showing examples of application process of the measuring program module group in the automatic measuring program of FIG. 12. FIG. 15 is an explanatory diagram showing application examples of the measuring parameter module group in the automatic measuring program of FIG. 12. FIG. 16 is an explanatory diagram showing application examples of the measuring instrument driver module group in the automatic measuring program of FIG. 12. FIG. 17 is an explanatory diagram showing customer evaluation support examples utilizing the automatic measuring program of FIG. 12. FIG. 18 is a flowchart showing customer evaluation support examples utilizing the automatic measuring program of FIG. 12.

In the second embodiment of the present invention, the sample evaluation system 1a for sample evaluation of the analog/digital-mixed semiconductor integrated circuit device 2, for example, includes, as shown in FIG. 10, a host 3 such as a personal computer, an evaluation board 4 and measuring instruments 6, 7.

The host 3 is also coupled respectively with the measuring instruments 6, 7 via GPIB (General Purpose Interface Bus) or LAN (Local Area Network).

The host 3 and measuring instruments 6, 7 may be coupled with a means other than the GPIB and LAN. In the case where an interface for enabling remote control of the measuring instruments is used as the means mentioned above, the measuring data may be transmitted or received by utilizing serial communication and wireless communication such as USB, RS232, and RS422, etc. Any kind of measuring instrument control interface can be used, when it can transmit and receive the data required for control of measuring instruments.

An automatic measuring program AP is installed to the host 3. The automatic measuring program AP administrates setting of the measuring instruments 6, 7 and acquisition of measuring data in order to control automatic measurement of the semiconductor integrated circuit device 2 as the evaluation object.

The measuring instrument 6 generates and outputs an input signal inputted to the evaluation board 4. The measuring instrument 7 measures the signal outputted from the evaluation board 4 and outputs this signal to the hest 3. Over the evaluation board 4, the semiconductor integrated circuit device 2 for the sample evaluation is mounted.

In addition, the host 3 and the evaluation board 4 are coupled, for example, via the serial communication cable 5. In the host 3, the serial communication cable 5 is coupled through the communication interface (for example, printer port) of the host 3. Coupling between this serial communication cable 5 and the host 3 may be made with a means other than the printer port and any type of interface for outputting the serial signal provided with the required number of terminals (for example, three or more terminals) for transmitting the data to the semiconductor integrated circuit device can be used for the connection explained above.

Moreover, coupling between the host 3 and the evaluation board can be made via the communication interface for outputting not only the serial signal but also the parallel signal. Further, the data may also be transmitted to the semiconductor integrated circuit device by utilizing the USB interface and wireless communication. Any type of general purpose interface may be utilized when it can transmit and receive the data required for sample evaluation.

FIG. 11 is an explanatory diagram showing examples of function contents of the automatic measuring program AP.

The automatic measuring program AP comprises a measuring condition input function JK, a measurement control function CK, a measurement result output function OK, a measuring condition storage function SK, a register setting function RK, and a measuring data analysis function KK.

The measuring condition input function JK is provided for inputting measuring conditions, while the measuring condition storage function SK is provided for storing the measuring condition inputted, the measurement control function CK is provided for controlling measurement, and the measurement result output function OK is provided for outputting the measurement result.

The register setting program RP is the function to control register of the semiconductor integrated circuit device 2, while the measuring data analysis function KK is provided to calculate and analyze the measurement result.

FIG. 12 is an explanatory diagram showing a structure of the automatic measuring program AP.

The automatic measuring program AP comprises a standard frame SF, the register setting program RP, measuring program control part KPC, measuring program module group KM, measuring program data file KF, measuring parameter module group PM, measuring driver module group DM and measuring condition data file JF explained in the first embodiment.

The standard frame SF is the user interface (GUI) for conducting basic manipulation with a pointing device such as a mouse by utilizing graphics for display of the information to users.

The register setting program RP includes the register setting main program RPM and register libraries RPL1 to RPLn provided for each product (kind) of the semiconductor integrated circuit device 2.

The register setting main program RPM is the general purpose program corresponding to all semiconductor integrated circuit devices for sample evaluation having the standard function not depending on product regarding the register control.

The measuring program control part KPC totally controls a plurality of programs of the measuring program module group KM. The measuring program module group KM includes a plurality of measuring program modules mp-1 to mp-N depending on a kind of the semiconductor integrated circuit device to be measured.

The measuring parameter module group PM includes a plurality of program modules p-1 to p-N for setting various parameters such as frequency, temperature and power supply voltage for measurement of the semiconductor integrated circuit device. The measuring driver module group DM includes a plurality of program modules d-1 to d-N as the drivers for virtually control the measuring instruments 6, 7 on the display screen of the host 2.

The measuring program data file KF stores various data of the measuring program module. This measuring program data file KF respectively stores the measuring items names of the semiconductor integrated circuit device to be measured and storing destination data of the program module.

The measuring condition data file JF stores various data of the measuring conditions. In this measuring condition data file JF, measuring parameters (name, setting value) and application restriction flags are stored.

The standard frame SF, register setting program RPM and measuring program control part KPC in the automatic measuring program AP are programs used in common for all products.

Moreover, the measuring program module group KM and measuring condition data file JF are programs used depending on the measuring item for measurement. The measuring parameter module group PM, measuring driver module group DM and the measuring program data file KF are programs used depending on a product field of the semiconductor integrated circuit device (for example, camera and mobile phone, etc.). The register libraries RPL1 to RPLn are programs used depending on the product of the semiconductor integrated circuit device.

FIG. 13 is an explanatory diagram showing examples of structures of the measuring programs mp-1, mp-2 in the measuring program module group KM.

As explained above, the measuring program module group KM includes measuring program module depending on a kind of the semiconductor integrated circuit device to be measured. For example, the measuring program module mp-1 comprises measuring parameters p-1, p-3, p-4 and measuring drivers d-1, d-2, d-4. Moreover, the measuring program module mp-2 comprises the measuring parameters p-1, p-4 and measuring drivers d-2, d-3, d-5.

Operations of the automatic measuring program AP in the second embodiment of the present invention will be explained below.

Application technique of the automatic measuring program AP in the measuring program module group KM will be explained first with reference to FIG. 14.

Information stored in the measuring program data file KF (measuring item name and storing destination of measuring program module) is read (step S201) and this stored information is then developed in the program table at the upper right side of FIG. 14 (step S202).

The measuring item name in the program table is GUI-displayed on the display screen of host 3 (step S203). In this case, application may be restricted by controlling the desired measuring items to the non-display items in view of providing the measuring program module corresponding to various customers and products.

Subsequently, when the desired measuring item name is selected from the program table displayed with the GUI-display process (step S204), a storing destination file path name of the measuring program module corresponding to the selected measuring item name can be extracted by referring to the program table developed by the process of the step S202 (step S205).

For example, in the case where the measuring item name “mp-1” is selected in the program table, the storing destination file path name becomes “C:¥File path mp-1”.

Thereafter, the desired measuring program module can be called from the measuring program module group KM indicated in the lower right side of FIG. 14 by calling in direct the extracted storing destination file path (step S206).

When the storing destination file path name is, for example, “C:¥File path mp-1” as explained above, the measuring program module “mp-1” is called from the measuring program module group KM. Here, a panel of the measuring program module called is GUI-displayed for application of the measuring program module (step S207).

Next, application technique of the measuring parameter module group PM in the automatic measuring program AP will be explained with reference to FIG. 15.

Information (measuring parameter, application restricting flag) stored in the measuring condition data file JF is read first from the standard frame SF and names of the applicable parameters are GUI-displayed.

The measuring parameters includes name and setting value. The setting value includes temperature, power supply voltage and operating frequency, etc., while the application restricting flag is set to show the applicable state or non-applicable state of the measuring parameters.

For instance, the parameters p-1, p-3, p-5 are applicable in the application restriction shown in the left side of FIG. 15 and the other parameters are set non-applicable. Accordingly, in the GUI-display process, only the applicable parameters p-1, p-3, and p-5 are displayed as indicated in the center of FIG. 14.

Moreover, the applicable parameters of GUI-display are respectively corresponding to the measuring parameter module of the measuring parameter module group PM as indicated in the right side of FIG. 15.

When an optional parameter module name of GUI-display is selected, the corresponding measuring parameter module is called for application thereof.

Even in this case, application may be restricted and the measuring program module corresponding to various customers and products can be provided by previously setting an application restricting flag to the measuring condition data file JF.

Next, application technique of the measuring instrument driver module group DM in the automatic measuring program AP will then be explained with reference to FIG. 16.

First, information stored in the measuring condition data file JF is read from the standard frame SF. In this case, the stored information includes name of measuring instrument, setting value, and application restricting flag. The application restricting flag is set to show applicable state or non-applicable state of the measuring instrument.

Only the applicable measuring instrument name is GUI-displayed on the basis of reading the stored information.

For example, in the case of application restriction indicated in the lower right side of FIG. 16, the measuring instruments d-1, d-2, and d-4 are applicable and the other measuring instruments are set non-applicable. Accordingly, in the case of GUI-display, only the applicable measuring instruments d-1, d-2, and d-4 are displayed as indicated in the center of FIG. 16.

Moreover, the applicable measuring instruments of GUI-display correspond respectively to the measuring instrument driver modules of the measuring instrument driver module group DM indicated in the right side of FIG. 16.

When the name of optional measuring instrument of GUI-display is selected, the corresponding measuring instrument driver module is called for application thereof.

Even in this case, application restriction can be set effectively and the measuring instrument driver module corresponding to various customers and products can be utilized by setting previously the application restricting flag to the measuring condition data file JF.

Next, the customer evaluation support technique utilizing the automatic measuring program AP will be explained with reference to FIG. 17 and FIG. 18.

First, the standard frame SF including the register setting main program RPM and measuring program control part KPC is previously provided to each user (step S301). On the occasion of evaluation of the semiconductor integrated circuit device, each information is provided in accordance with the products evaluated by each customer (evaluation kits HK1, HK2).

For example, when a customer a indicated in FIG. 18 evaluates the semiconductor integrated circuit device of the product A, the evaluation kit HK1 comprising the register library according to the product A, the measuring program data file KF (mp-1) and measuring program module group KM (mp-1) according to the product A, the measuring condition data file JF (p-1, p-3, p-5, d-1, d-2, d-4), measuring parameter module group PM (p-1, p-3, p-5) and measuring instrument driver module group DM (d-1, d-2, d-4) according to the product A is provided in the form of a storage medium or through the communication line such as the Internet (step S302).

Moreover, to a customer b evaluating the semiconductor integrated circuit device of the product B, the evaluation kit HK2 comprising the register library according to the product B, the measuring program data file KF (mp-2) and measuring program module group KM (mp-2) according to the product B, the measuring condition data file JF (p-1, p-4, d-2, d-3, d-5), measuring parameter module group PM (p-1, p-4) and measuring instrument driver module group DM (d-2, d-3, d-5) according to the product B is provided in the form of a storage medium or through the communication line such as the Internet (step S302).

Similarly, to a customer c evaluating the semiconductor integrated circuit devices of the products A and B, the evaluation kits HK1, HK2 comprising the register library according to the products A, B, the measuring program data file KF and measuring program module group KM according to the products A, B, the measuring condition data file JF, measuring parameter module group PM and measuring instrument driver module group DM according to the products A, B are provided in the form of a storage medium or through the communication line such as the Internet (step S302).

In this case, since the application restriction corresponding to each customer (or product) as explained above is set to the measuring program data file KF and the measuring condition data file JF, customers are capable of automatically evaluating the semiconductor integrated circuit device by utilizing the measuring program module, measuring parameter module and measuring instrument driver module which are optimum for the garget product (step S303).

Therefore, according to the second embodiment of the present invention, since the flexible automatic measurement can be realized for various kinds of the semiconductor integrated circuit device only by changing combination of the measuring program module group KM, measuring parameter module group PM, measuring instrument driver module group DM, register library RPL, measuring program data file KF and measuring condition data file JF, development cost of programs can be reduced remarkably.

In addition, since the register library RPL, measuring program data file KF and measuring condition data file JF can be easily provided additionally to customers, the automatic measurement environment of the relevant products can be established easily within a short period of time and thereby product evaluation period in the customer side can also be shortened distinctively.

Furthermore, the measuring program corresponding to the relevant products can be generated by optionally selecting and combining the measuring program module group KM, measuring parameter module group PM, measuring instrument driver module group DM, register library RPL, measuring program data file KF and measuring condition data file JF in accordance with the measuring conditions of the semiconductor integrated circuit device of customers. Accordingly, customers are capable of conducting product evaluation of the semiconductor integrated circuit device using the generated measuring programs. In addition, even when specifications of the semiconductor integrated circuit device are changed, the automatic measurement environment of the relevant product can be established easily within a short period of time by changing the measuring conditions. Accordingly, the optimum measuring program can be provided to realize remarkably reduce the product evaluation period in the side of customers.

Although the preferred embodiments of the present invention have been described above concretely, the present invention is not restricted by these embodiment described above and allows numerous variations and modifications within the scope of the following claims.

The present invention provides the techniques for effectively conducting sample evaluation within a short period of time in lower development cost in accordance with register structure and various measuring conditions of the semiconductor integrated circuit device for each product by utilizing general purpose software.

What is claimed is:

1. A design method of semiconductor integrated circuit device comprising:
a register setting program core as a general purpose program corresponding to all semiconductor integrated circuit device for sample evaluation having standard function not depending on product regarding register control; and
a plurality of register libraries comprising data prepared in accordance with register structure individually corresponding to each product of the semiconductor integrated circuit device,
wherein each of the register libraries comprises, for each product, an address for designating an optional register at least in the semiconductor integrated circuit device, and a word information indicating data stored in the register, and
wherein, among the register libraries, the register library corresponding to register structure of the semiconductor integrated circuit device for evaluation of trial manufacture is selected when evaluation of trial manufacture of the optional semiconductor integrated circuit device is conducted.

2. The design method of semiconductor integrated circuit device according to claim 1,
wherein, the register library stores bit length of the word information.

3. The design method of semiconductor integrated circuit device according to claim 1,
wherein the register setting program core has a GUI control function to display GUI parts and register map,
wherein the register library has GUI information to change structure and display of a manipulating function displayed by the GUI control function, and
wherein the word information is changed by the GUI displayed manipulating function.

4. The design method of semiconductor integrated circuit device according to claim 1,
wherein the register library comprises serial communication pattern information outputted by a serial signal, and
wherein the serial communication pattern information outputs the word information after conversion into the communication pattern of the serial signal.

5. The design method of semiconductor integrated circuit device according to claim 4,
wherein the serial communication pattern information includes information for assigning transmitting and receiving terminals in the communication interface on the occasion of outputting the communication pattern of the serial signal.

6. The design method of semiconductor integrated circuit device according to claim 1,
wherein the register library has a data inter-relating function for setting inter-relation among the data, and
wherein the data inter-relating function, when the word information of optional register is changed to the optional setting condition, automatically changes the data included in the word information of all registers related to the optional register on the basis of the data inter-relating information.

7. A program, which can be executed with a computer coupled to a semiconductor integrated circuit device including analog circuit and used for controlling operations of the analog circuit,
the program comprising a process of controlling a computer for enabling:
reading of defining information for defining a register corresponding to the analog circuit;
setting information to be set to the register on the computer;
setting of the set information to the register;
controlling of operations of the analog circuit; and
input of the information outputted from the semiconductor integrated circuit device in accordance with operations of the semiconductor integrated circuit device.

8. The program according to claim 7,
wherein the program comprises a step of selecting, from defining information pieces for defining a plurality of registers, register defining information in accordance with the analog circuit of the coupled semiconductor integrated circuit device.

9. The program according to claim 7,
wherein the computer is further coupled to measuring instruments for measurement of operations of the analog circuit by the measuring instruments, and the program includes a step of controlling the computer to allow input of measuring information measured by the measuring instruments.

10. The program according to claim 9, comprising a step of controlling the computer to allow setting of the set information to the measuring instruments by setting information to be set to the measuring instruments.

11. A program executed with a computer coupled to a semiconductor integrated circuit device having an analog circuit and used for measuring operations of the semiconductor integrated circuit device, comprising:
a program for evaluation control of the semiconductor integrated circuit device;
a program for measuring semiconductor integrated circuit device constituted for allowing switching corresponding to product identifying information to identify the semiconductor integrated circuit device;
a measuring parameter in accordance with the measuring program; and
measuring instrument drivers in accordance with the measuring program,
the program further comprising a process of controlling a computer for enabling:
read of product identifying information of the semiconductor integrated circuit device as an object of the measuring operation due to execution of the program;
selection of the measuring program in accordance with the product identifying information;
selection of the measuring parameter in accordance with the selected measuring program;
selection of the measuring parameter in accordance with the selected measuring program; and
measuring operation of the semiconductor integrated circuit device by utilizing the evaluation control program, the measuring program selected in accordance with the product identifying information, the measuring parameter, and the measuring instrument drivers.

12. The program according to claim 11,
wherein the measuring program selected from a plurality of measuring programs in accordance with the produce identifying information comprises a step of:
setting a continuous measuring operation to continuously execute the measuring programs and single measuring operation to execute one measuring program.

13. The program according to claim 11,
wherein the measuring parameter selected from the measuring parameters in accordance with the measuring program includes parameters further including power supply voltage, operating frequency and temperature of the semiconductor integrated circuit as the measuring object and amplitude and frequency of the input/output signals, and
wherein the program includes a step of switching and setting the measuring parameters as the same product identifying information and in accordance with switching of a plurality of selected measuring programs.

14. The program according to claim 11,
wherein the measuring instrument driver selected from the measuring instrument drivers in accordance with the measuring program is capable of operating a measuring instrument coupled to the computer used upon measuring operations of the semiconductor integrated circuit device, and
wherein the program comprises a step of controlling the computer so as to input measuring information measured by the measuring instruments through the execution of the program.

15. The program according to claim 11, comprising a step of newly adding the measuring parameters on the computer or restricting application of the same measuring parameters.

16. The program according to claim 11, comprising a step of newly adding the measuring instrument drivers on the computer.

17. A measurement evaluation support method of a semiconductor integrated circuit device for conducting measurement evaluation of the semiconductor integrated circuit device using the program according to claim 11 which has been determined by selecting the measuring program, measuring parameter, and measuring instrument drivers in accordance with the measuring conditions of the semiconductor integrated circuit device.
